(19) United States
(12) Patent Application Publication
(10) Pub. No.: US 2014/0217961 A1
(43) Pub. Date: Aug. 7, 2014

(54) PORTABLE POWER SUPPLY HAVING LOWER CHARGING VOLTAGE THAN DISCHARGING VOLTAGE

(71) Applicant: ZONESKING TECHNOLOGY CO., LTD., New Taipei City (TW)

(72) Inventors: TZU-YU YANG, New Taipei City (TW); YI-AN CHEN, Taichung City (TW); JIA-YI WU, New Taipei City (TW)

(73) Assignee: ZONESKING TECHNOLOGY CO., LTD., New Taipei City (TW)

(21) Appl. No.: 14/069,389

(22) Filed: Nov. 1, 2013

(30) Foreign Application Priority Data
Feb. 7, 2013 (TW) 102202809

(51) Int. Cl. H02J 7/00

(52) U.S. Cl. CPC H02J 7/0013
USPC 320/107

(57) ABSTRACT

The portable power supply contains at least a first battery, at least a second battery, at least a first switch element, at least a second switch element, a plurality of charging and regulating circuits, an input interface element, and an output interface element. Each second battery is electrically connected in series with a first battery through a first switch element. Each second switch element is electrically connected in-series between ground and a first battery or a second battery. Each charging and regulating circuit is electrically connected to a first battery or a second battery The input interface element has an end electrically connected to an external power source, and another end electrically connected to all charging and regulating circuits. The output interface element has an end electrically connected to an external electronic device, and another end electrically connected to a first battery or a second battery.

### TECHNICAL FIELD OF THE INVENTION

The present invention is generally related to portable power supplies, and more particular to a portable power supply requiring a lower charging voltage than its discharging voltage.

### DESCRIPTION OF THE PRIOR ART

Due to the increasing popularity of portable consumer appliances such as smart phones, tablet computers, and notebook computers, demand and expectation to portable power supplies also increase significantly. Portably power supplies are constantly required to have greater stored capacity and higher discharging voltage. For example, some portable consumer appliances such as car electronic devices, large notebook or table computers, power tools, digital stereos requiring more than 12V working voltage. A common approach to such requirement is to series-connect two or more batteries.

However, this type of portable power supplies has the following disadvantages.

Firstly, for conventional lithium or related batteries, higher charging voltage is required as more batteries are series-connected. For example, the charging voltage has to be greater than 8.4V for two batteries, 12.6V for three batteries, and 16.8V for four batteries. Due to the higher charging voltage requirement, the convenience of charging the portable power supply is compromised.

This type of portable power supplies usually requires a proprietary adaptor and has to be charged at where the mains electricity is available.

Except one with two series-connected batteries, other ones having more series-connected batteries cannot be charged on an automobile.

The type of portable power supplies also cannot be charged by a computer's USB interface, or by a commonly seen 5V Micro-USB adaptor.

The production of this type of portable power supplies also has difficulties.

For example, the batteries have to be carefully chosen so that they share similar characteristics. Therefore, the more batteries to be series-connected, the greater purchasing and production cost is incurred.

Secondly, when more batteries are series-connected, the charging circuit is more complex as the status of each battery has to be monitored so that hazard is prevented from imbalanced charging to the batteries. Therefore more electronic parts are required for the safety of the portable power supply and the cost is inevitably increased.

Thirdly, when one of the series-connected battery breaks down, the entire portable power supply is rendered useless, this is not environmentally friendly.

### SUMMARY OF THE INVENTION

Therefore, a novel portable power supply is provided herein. The portable power supply contains at least a first battery, at least a second battery, at least a first switch element, at least a second switch element, a plurality of charging and regulating circuits, an input interface element, and an output interface element. Each second battery is electrically connected in series with a first battery through a first switch element. Each first switch element is electrically connected in-series between a first battery and a second battery. Each second switch element is electrically connected in-series between ground and a first battery or a second battery. Each charging and regulating circuit is electrically connected to a first battery or a second battery. The input interface element has an end electrically connected to an input connection element for electrically connecting the input interface element with an external power source, and another end electrically connected to all charging and regulating circuits. The output interface element has an end electrically connected to an output connection element for electrically connecting the output interface element with an external electronic device, and another end electrically connected to a first battery or a second battery.

A major objective of the present invention is that, no matter of the type of batteries, the charging voltage is required only to be higher than the discharging voltage of each battery Taking the lithium battery as example, regardless of the number of batteries series-connected, each battery's charging voltage is only required to be higher than 4.2V. Therefore, the portable power supply can be charged from whatever source having 5V output voltage, and such source is rather common, such as the USB interface of a computer, the % V Micro-USV adaptor, the 12V cigarette lighter interface on an automobile. In other words, the portable power supply can basically be charged pretty much at all places.

A secondary objective of the present invention is that the batteries can be conveniently chosen as long as their capacities are compatible. There is also no need for specialized charging and protection circuit. The batteries are also not directly connected and, therefore, if any one of the batteries breaks down, only that broken battery should be replaced.

As described above, therefore, the portable power supply can be charged with a much smaller voltage, instead of using a higher charging voltage than the sum of output voltages of the series-connected batteries.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become apparent to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram showing the various components of a portable power supply according to an embodiment of the present invention.

FIG. 2 is a schematic diagram showing the charging to a portable power supply of the present invention having only a first battery and a second battery.

FIG. 3 is a schematic diagram showing the discharging from a portable power supply of the present invention having only a first battery and a second battery.

FIG. 4 is a functional block diagram showing the portable power supply of FIG. 2.

FIG. 5 is a functional block diagram showing the portable power supply of FIG. 3.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

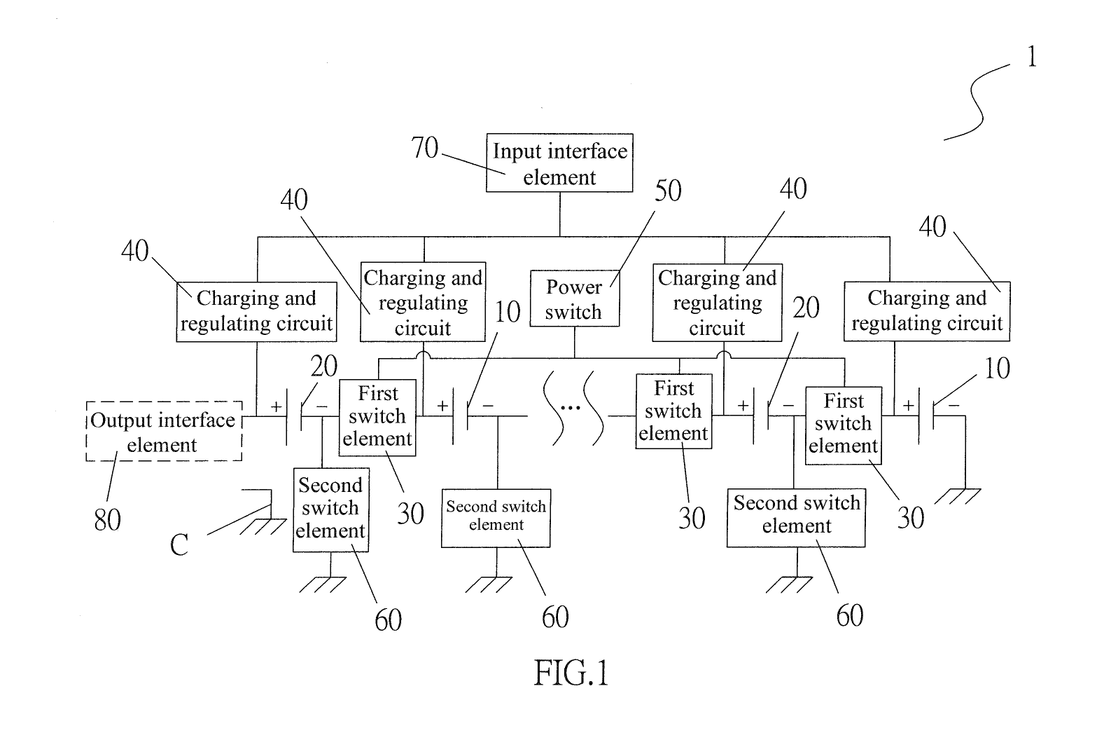

As illustrated in FIGS. 1 to 3, a portable power supply 1 according to an embodiment of the present invention contains at least a first battery 10, at least a second battery 20, at least a first switch element 30, at least a second switch element 60, a number of charging and regulating circuits 40, a power switch 50, an input interface element 70, and an output interface element 80.

Each first battery 10 is a rechargeable battery.

Each second battery 20 is also a rechargeable battery, and is electrically connected in series with a first battery 10 through a first switch element 30 (as described below).

A pair of series-connected first and second batteries 10 and 20 constitutes a zone of batteries, and each first or second battery 10 or 20 can contain two or more series-connected smaller batteries.

Each first switch element 30 is electrically connected in-series between a first battery 10 and a second battery 20. More specifically, an end of the first switch element 30 is electrically connected to a positive terminal of the first battery 10 and the other end of the first switch element 30 is electrically connected to a negative terminal of the second battery 20.

The positive terminal of each first and second battery 10 and 20 is electrically connected to a charging and regulating circuit 40, which provides a stable voltage to the connected first or second battery 10 or 20.

The power switch 50 is electrically connected to all first switch elements 30. The power switch 50, when engaged, turns on all first switch elements 30 simultaneously so that all first and second batteries 10 and 20 are series-connected and discharged altogether.

The negative terminal of each first and second battery 10 and 20 is electrically connected to ground through a second switch element 60. When a second switch element 60 is turned on, the connected first or second battery 10 or 20 allows itself to be charged by the connected charging and regulating circuit 40.

Each first and second switch element 30 and 60 can be one of a MOS electronic component, a transistor, a relay, a semiconductor, and a mechanical switch. The foregoing is only exemplary and is not intended to limit the present invention as such.

The present invention does not limit the number of first and second batteries 10 and 20. There can be multiple first and second batteries 10 and 20 series-connected, together with corresponding numbers of charging and regulating circuits 40, first switch elements 30, and second switch elements 60, as described above.

The input interface element 70 has an end electrically connected to an input connection element 71, and another end electrically connected to all charging and regulating circuits 40. The input connection element 71 is for electrically connecting the input interface element 70 with an external power source A.

The output interface element 80 has an end electrically connected to an output connection element 81, another end electrically connected to a positive terminal of a first battery 10 or a second battery 20, and yet another end electrically connected a common ground point C. The output connection element 81 is for electrically connecting the output interface element 80 with an external electronic device B.

The input and output interface elements 70 and 80 can be USB (Universal Serial Bus) connectors or DC connectors conforming to various standards. The USB and DC connectors are exemplary only and are not intended to limit the present invention as such.

Additionally, the connection to the first or second battery 10 or 20 and the common ground point C can be modularized for enhanced flexibility. Therefore, various types of the output interface elements 80 can be used, instead of using only USB or DC connector.

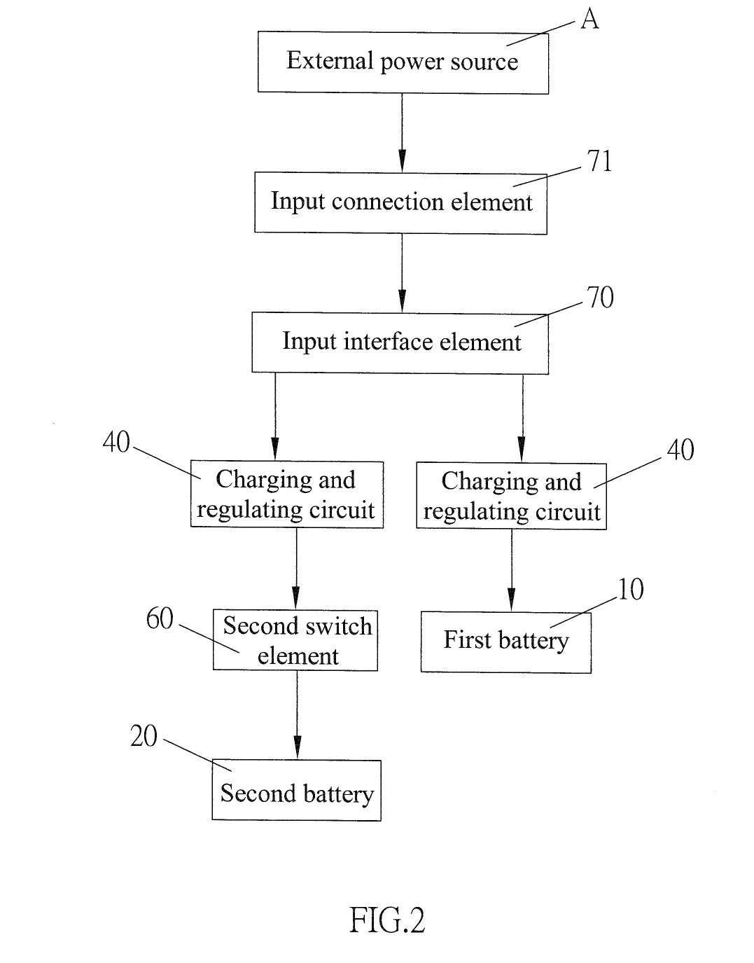

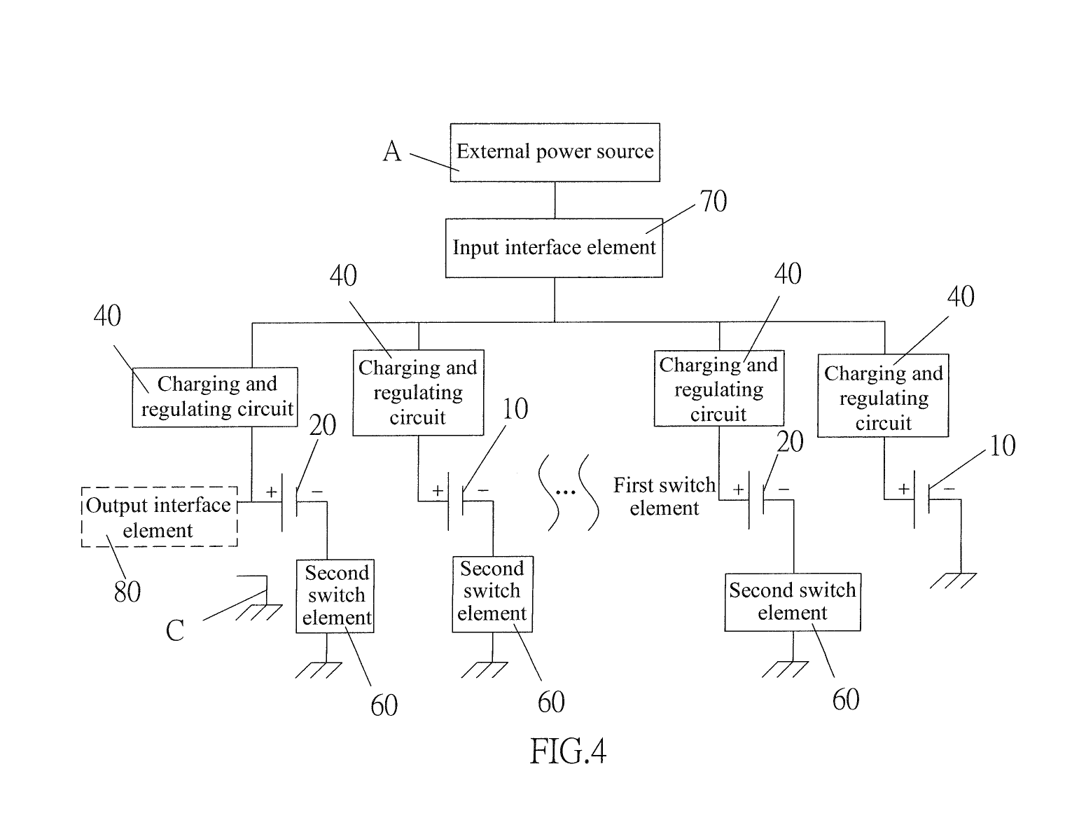

As shown in FIGS. 2 and 4, when the portable power supply 1 is charged, the input connection element 71 connects the input interface element 70 to the external power source A. By the electricity of the external power source A, the second switch elements 60 are all turned on whereas the first switch elements 30 are all turned off As such, an independent close circuit is formed from each charging and regulating circuit 40, through a first or second battery 10 or 20 connected to the charging and regulating circuit 40, and a second switch element 60 connected to the first or second battery 10 or 20, and then to the ground. The electricity of the external power source A charges simultaneously and independently the first and second batteries 10 and 20.

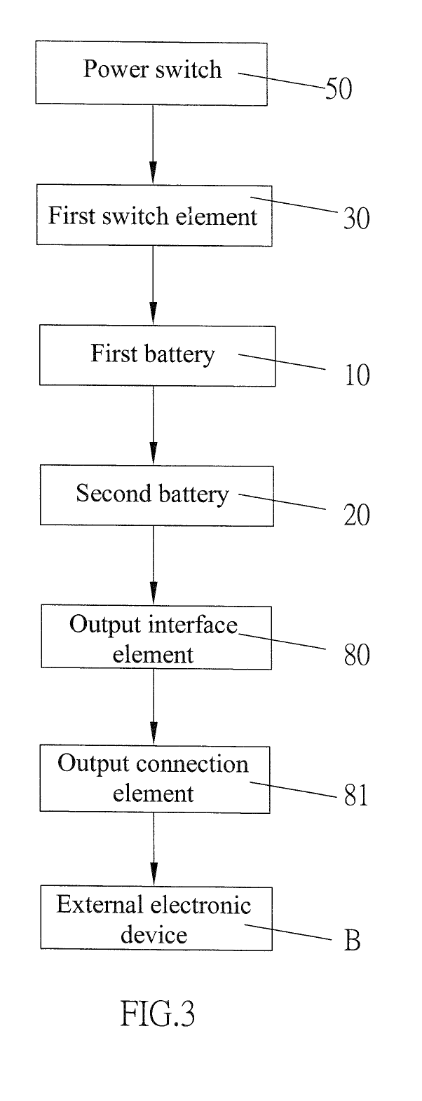

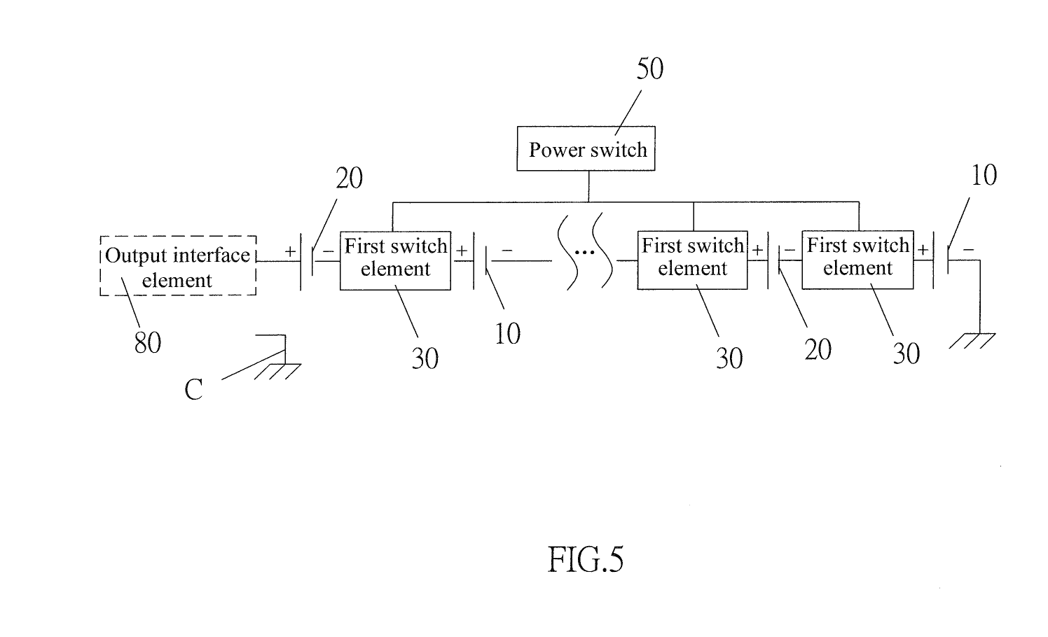

As shown in FIGS. 3 and 5, to use the portable power supply 1 to power an external electronic device B, the output connection element 81 connects the output interface element 80 to the external electronic device B. Then, when the power switch 50 is engaged, the first switch elements 30 are all turned on whereas the second switch elements 60 are all turned off As such, the first and second batteries 10 and 20 are all connected in a series so as to power the external power electronic device B altogether.

For example, there are total n first and second batteries 10 and 20, and Vb1, Vb2, . . . , Vbn are the voltages of all batteries.

The output voltage Vo of the portable power supply 1 is equal to Vb1+Vb2+ . . . +Vbn.

Conventionally, for a battery having Vo output voltage, the charging voltage Vc has to be greater than Vo.

However, as described above, to charge the portable power supply, the charging voltage Vc is only required to be greater than Vb (i.e., the output voltage of each first and second batteries 10 and 20).

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A portable power supply, comprising:
at least a first battery;
at least a second battery;
at least a first switch element;
at least a second switch element;
a plurality of charging and regulating circuits;
an input interface element; and
an output interface element;
wherein each second battery is electrically connected in series with a first battery through a first switch element;
each first switch element is electrically connected in-series between a first battery and a second battery;
each second switch element is electrically connected in-series between ground and a first battery or a second battery;
each charging and regulating circuit is electrically connected to a first battery or a second battery;
the input interface element has an end electrically connected to an input connection element for electrically connecting the input interface element with an external power source, and another end electrically connected to all charging and regulating circuits; and the output interface element has an end electrically connected to an output connection element for electrically connecting the output interface element with an external electronic device, another end electrically connected to a first battery or a second battery and yet another end electrically connected a common ground point.

2. The portable power supply according to claim 1, further comprising a power switch electrically connected to all first switch elements, wherein the power switch, when engaged, turns on all first switch elements simultaneously so that all first and second batteries are series-connected and discharged altogether.

3. The portable power supply according to claim 1, wherein, when the input connection element connects the input interface element to the external power source, the second switch elements are all turned on whereas the first switch elements are all turned off; and, as such, the external power source charges all first and second batteries through a charging and regulating circuit 40 simultaneously and independently.

4. The portable power supply according to claim 1, wherein each first and second switch element is one of a MOS electronic component, a transistor, a relay, a semiconductor, and a mechanical switch.

5. The portable power supply according to claim 1, wherein a pair of series-connected first and second batteries constitutes a zone of batteries; and each first or second battery comprises a plurality of series-connected smaller batteries.
